(19) United States
(12) Patent Application Publication
(10) Pub. No.: US 2019/0053656 A1
(43) Pub. Date: Feb. 21, 2019

(54) BEVERAGE MACHINE AND METHOD FOR PRODUCING COFFEE-BASED BEVERAGES

(71) Applicant: EVERSYS Holding SA, Ardon (CH)

(72) Inventor: Grégoire LOCHER, Daillon (CH)

(73) Assignee: EVERSYS Holding SA, Ardon (CH)

(21) Appl. No.: 16/101,801

(22) Filed: Aug. 13, 2018

(30) Foreign Application Priority Data
Aug. 17, 2017 (EP) 17 186 562.9

(51) Int. Cl. A47J 31/36

(52) U.S. Cl. CPC A47J 31/3609; A47J 31/56

(57) ABSTRACT

A beverage machine for producing coffee-based beverages includes a pump supplying pressurized water; a heater heating the water; a brewing chamber, which is fillable with coffee powder; piping in fluid connection with the pump, heater and brewing chamber for conducting pressurized water into the brewing chamber; and a dispensing device dispensing coffee-based beverage produced in the brewing chamber by brewing the coffee powder with the water. The piping has a first feed pipe between the pump and heater and a second feed pipe between the heater and brewing chamber. The second feed pipe has at least a first valve. A cooler is arranged in the second feed pipe downstream of the first valve for cooling water heated by the heater, to enable production of coffee-based beverages having different temperatures, in particular temperatures below 50° C., which allow pouring the produced beverage into a bio-degradable cup made of polylactic acid (PLA).

### FIELD OF THE DISCLOSURE

The disclosure relates to a beverage machine for producing coffee-based beverages. The disclosure further relates to a method for producing coffee-based beverages in a beverage machine.

### BACKGROUND

Coffee-based beverages, as for example espresso, cappuccino, milk-coffee, white coffee or flavoured coffee blended with aromas, nowadays are very widespread and popular and are available in many different forms, in particular in terms of their starting blend and the way in which the beverage is extracted. Coffee machines for producing coffee-based beverages and methods for producing coffee-based beverages in a beverage machine are widely known in the prior art. In common coffee machines, hot water is passed through a layer of ground coffee (coffee powder) contained in a brewing chamber or an infusion container, as for example a metal filter. The water passing through the layer of ground coffee generally is heated to temperatures between 85° C. to 110° C. and is conducted under a certain pressure into the brewing chamber or the infusion container, in order to brew the ground coffee. The type of the coffee-based beverage produced and its blend and flavour highly depends on the temperature and pressure of the water directed through the ground coffee.

European patent application EP 2 314 183 A1, for example, is disclosing a coffee machine provided with a water pressure regulation and a method for controlling the pressure in the filter chamber of a coffee machine. The coffee machine disclosed, is comprising a hydraulic pump, at least one dispensing device comprising a filter unit, which is serving as a brewing chamber and is fillable with ground coffee, and a supply unit for supplying water to the filter unit. A hydraulic circuit brings the hydraulic pump into fluid communication with the supply unit of the dispensing device and the hydraulic circuit is comprising a supply duct which supplies hot water under pressure to the supply unit. The coffee machine is further comprising a system for controlling the dispensing pressure, which comprises a control unit, a pressure sensor disposed along the hydraulic circuit and apt to generate a control signal representative of the pressure detected, the pressure sensor being electronically connected to a control unit to detect the dispensing pressure, and a hydraulic variable-flow valve is disposed along the hydraulic circuit and apt to supply variable quantities of water to at least one dispensing device, the variable-flow valve being actuated by an electronic drive controlled electronically by the control unit in order to regulate the flow rate of water output as a function of a detected dispensing pressure value.

The presentation of coffee-based beverages in disposable cups as “coffee-to-go” products is also very popular. Concerning the use of disposable cups, the market is more and more sensitive to pollution and customers request the usage of recyclable or bio-degradable cups, as for example PLA (polylactic acid) cup systems. PLA is a synthetic polymer compound based on corn and is completely bio-degradable. From PLA, cups can be produced by thermoforming. The use of this type of cup as containers for hot coffee, however, is raising problems, because the maximum authorised temperature of the contents is 50° C. At temperatures above 50° C., the PLA cups are melting. Therefore, a desire is existing to produce coffee-based beverages in coffee-machines which can be filled into PLA cups. There is also a need to produce coffee-based beverages having a temperature of 50° C. or lower, when filled into a disposable cup made of a recyclable or bio-degradable material.

In some countries, the provision of water having drinking water quality is a problem. Accordingly, there is a need to provide a beverage machine and a method to produce sterile coffee-based beverages with non-potable water lacking drinking water quality.

In general, there is a need for a beverage machine for producing coffee-based beverages, wherein the machine is able to produce different kinds of beverages having different temperatures, as for example hot coffee, warm coffee or cold coffee.

### SUMMARY

The disclosure relates to a beverage machine for producing coffee-based beverages, and a method for producing coffee-based beverages in a beverage machine.

The beverage machine according to the disclosure comprises a pump to supply pressurized water, a heater for heating the water supplied by the pump to a predefined heating temperature, a brewing chamber, which can be filled with coffee powder (ground coffee) and a piping being in fluid connection with the pump, the heater and the brewing chamber for conducting pressurized water into the brewing chamber, wherein the piping is comprising a first feed pipe between the pump and the heater and a second feed pipe between the heater and the brewing chamber and the second feed pipe is comprising at least a first valve, and a dispensing device for dispensing the coffee-based beverage produced in the brewing chamber by brewing the coffee powder with water supplied by the pump. In order to enable the feed of water having different temperatures into the brewing chamber, a cooler is arranged in the second feed pipe downstream of the first valve for cooling the water heated by the heater to a desired temperature, which is lower than the heating temperature.

The beverage machine according to the disclosure enables to brew the coffee powder with hot water or with cold water or with any desired water temperature between hot and cold. In particular, it is enabled to brew the coffee powder with hot water having temperatures between 85° C. and 110° C., or with cold water having temperatures in the range of room temperature (e.g. around 20° C.) or with any desired water temperature between room temperature and boiling temperature of water. Preferably, the natural water supplied by the pump is heated in the heater to temperatures above 60° C., to ensure that bacteria and viruses present in the supplied water are thermally killed. This enables to feed the beverage machine also with non-potable water lacking drinking water quality, without any health risks for the consumer of the brewed beverage, because the brewed beverage is sterilized by heating the water to temperatures, which are high enough to kill viruses and bacteria.

The cooler preferably is cooling the heated water at least to a temperature which is sufficiently low, to ensure that the product temperature of the produced beverage is 50° C. at maximum, in order to enable that the beverage can be poured in a PLA cup without melting the cup material. In any case, the cooler is cooling the heated water more than the ambient heat transfer will cool the heated water on its way from the heater to the brewing chamber.

The first valve arranged in the second feed pipe preferably is a switching valve (directional control valve), in particular a solenoid valve.

In a first embodiment of the beverage machine according to the disclosure, the cooler is a mixer which is mixing heated water outgoing of the heater with cold water supplied by the first feed pipe.

In the first embodiment, the piping of the beverage machine preferably comprises a connecting pipe connecting the first feed pipe and the second feed pipe and the mixer is comprising a second valve arranged in the connecting pipe. Thus, in this first embodiment, when the second valve is open, cold water supplied by the first feed pipe can be fed through the connecting pipe into the second feed pipe for mixing with heated water outgoing of the heater. By the mixing of the water heated in the heater with the cold water supplied by the first feed pipe, the water which is fed into the brewing chamber has an intermediate temperature, being the average of the heating temperature and the temperature of the cold water supplied by the first feed pipe.

In the first embodiment, the second valve can be a switching valve (directional control valve), in particular a solenoid valve, or a variable-flow valve, in particular a proportional valve. When the second valve is a proportional valve, the temperature of the mixed water fed into the brewing chamber can be chosen by a fine adjustment of the amount of cold water flowing from the first feed pipe through the second valve into the second feed pipe.

In a second embodiment of the beverage machine according to the disclosure, the cooler is a heat exchanger, which is thermally coupling the first feed pipe and the second feed pipe for cooling the heated water fed by the second feed pipe to the brewing chamber. This embodiment enables to supply the beverage machine with water lacking drinking water quality, since the water, which is fed into the brewing chamber, is sterilized by heating to temperatures above 60° C. and the cold water having temperatures lower than 60° C. comes not into contact with the brewing chamber.

In the second embodiment, the beverage machine preferably comprises a bypass pipe, which is bypassing the heat exchanger, to feed heated water outgoing of the heater directly into the brewing chamber. This enables to feed the brewing chamber with hot water without cooling it, in particular with hot water in the temperature range of 85° C. to 110° C., which is best suited for extracting the maximum flavour of the coffee powder.

For feeding hot water heated in the heater directly into the brewing chamber, also in the second embodiment, a second valve in the form of a three-way valve can be arranged in the second feed pipe downstream of the first valve. Preferably, the second valve is a proportional valve. The input side of the second valve is connected by the second feed pipe with the heater and the first output side of the second valve is connected to the heat exchanger and the second output side of the second valve is connected to the bypass pipe, which is bypassing the heat exchanger. This enables to direct at least a part of the hot water heated in the heater without cooling it through the first output side of the second valve directly into the brewing chamber. The rest of the hot water heated in the heater can be directed through the second output side of the second valve into the heat exchanger, where the water is cooled by heat transfer with the cold water supplied by the first feed pipe to the heat exchanger. When the second valve is a proportional valve, the amount of water carried directly into the brewing chamber can be chosen by regulating the water flow through the first output side of the second valve.

In both embodiments of the disclosure, a pressure sensor can be arranged in the first feed pipe, downstream of the pump, in order to measure the pressure of the water supplied by the pump into the first feed pipe.

Further, in both embodiments of the disclosure, at least one temperature sensor is preferably arranged in the second feed pipe, in order to measure the temperature of the water carried into the brewing chamber. A first temperature sensor may be arranged in the second feed pipe directly downstream of the heater for detecting the temperature of the outgoing water of the heater and/or a second temperature sensor preferably is arranged in the second feed pipe directly upstream of the brewing chamber for detecting the temperature of the water fed into the brewing chamber.

Also in both embodiments of the disclosure, the dispensing device preferably is comprising an outlet pipe for discharging the beverage into a container, particularly a PLA cup. In order to avoid that the temperature of the beverage is higher than 50° C. when a PLA cup is used, a third temperature sensor is arranged in the outlet pipe for determining the temperature of the beverage. The controlling system of the machine is stopping the discharge of the beverage, if the third sensor is sensing a beverage temperature higher than 50° C.

In both embodiments of the disclosure, preferably a bypass pipe, which is bypassing the brewing chamber, is included in the piping system. This bypass pipe is connecting the second feed pipe with the outlet pipe and enables to mix the brewed coffee flowing out of the brewing chamber and into the outlet pipe with cold, warm or hot water, in order to modify the flavour profile of the produced coffee-based beverage. For closing and opening the bypass pipe, a bypass valve in the form of a switching valve is arranged in the bypass pipe. Further, a throttle valve may be arranged in the bypass pipe.

Another important parameter for defining a flavour profile of the coffee-based beverage produced with the machine according to the disclosure is the powder quantity that is filled in the brewing chamber. To be able to detect the powder quantity, the brewing chamber therefore appropriately is coupled with a portion sensor, in particular with a weighing sensor located at the bottom of the brewing chamber. Once a predefined powder quantity is reached upon filling coffee powder in the brewing chamber, the control system of the beverage machine will interrupt the (automatic) coffee powder filling.

In the method according to the disclosure, the following steps are (automatically) performed in a beverage machine:
supplying pressurized water to a heater,
heating the supplied water in the heater to temperatures of at least 60° C., preferably to more than 80° C.,
filling a brewing chamber with coffee powder,
conducting the water heated in the heater into the brewing chamber filled with coffee powder for brewing the coffee powder, thereby producing the coffee-based beverage,
dispensing the coffee-based beverage produced in the brewing chamber by a dispensing device,
   wherein the water heated by the heater is cooled in a cooler before the water is conducted into the brewing chamber.

Preferably, the water is heated in the heater to temperatures between 80° C. and 110° C. The water heated by the heater is cooled in the cooler to such an extent, that the temperature of the produced beverage is 50° C. or lower. The temperature of the produced beverage may be sensed by a product temperature sensor arranged in the dispensing device, and dispensing of the coffee-based beverage is stopped, if this product temperature sensor is detecting a product temperature of more than 50° C.

### BRIEF DESCRIPTION OF THE DRAWINGS

Below, the embodiments of the disclosure are described in further detail with reference to the accompanying drawings, which show:

FIG. 1: a hydraulic circuit of a first embodiment of a beverage machine according to the disclosure;

FIG. 2: a hydraulic circuit of a second embodiment of a beverage machine according to the disclosure;

FIG. 3: a hydraulic circuit of a modification of the first embodiment of a beverage machine according to the disclosure;

### DETAILED DESCRIPTION

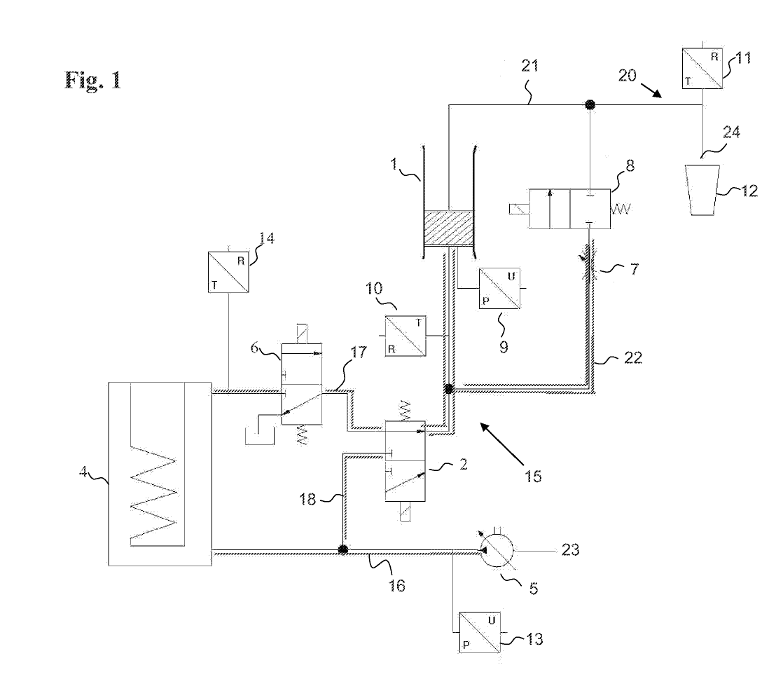

The first embodiment of a beverage machine according to the disclosure shown in FIG. 1 is for use with drinkable water to be supplied to the machine.

The hydraulic circuit shown in FIG. 1 comprises a cold-water inlet 23 connected to a piping 15 with a first feed pipe 16, a second feed pipe 17, a pump 5 to supply pressurized water, a heater 4 for heating the water supplied by the pump 5, a brewing chamber 1, which is fillable with coffee powder, and a dispensing device 20 with an outlet pipe 21 having an outlet 24. One end of the first feed pipe 16 is connected to the cold-water inlet 23 via the pump 5 and the other end of the first feed pipe 16 is connected to the heater 4. The second feed pipe 17 is connecting the heater 4 and the brewing chamber 1. Thus the piping 15 is fluidly connecting the pump 5, the heater 4 and the brewing chamber 1 for conducting pressurized water into the brewing chamber 1. The second feed pipe 17 is including a first valve 6, which is a 3-port/2-way valve in the embodiment shown in FIG. 1. The first valve 6 is a directional control valve, for example a solenoid valve.

The piping 15 is further comprising a connecting pipe 18 connecting the first feed pipe 16 and the second feed pipe 17. In the connecting pipe 18, a second valve 2 is arranged. In the embodiment shown in FIG. 1, the second valve 2 is a directional control 3-port/2-way valve. The connecting pipe 18 and the second valve 2 are building a mixer, by which heated water outgoing of the heater 4 can be mixed with cold water supplied by the first feed pipe 16. Since the temperature of the mixed water is lower than the temperature of the hot water heated in the heater 4, the mixer is acting as a cooler, which is cooling the heated water to a lower temperature. In order to cool the water heated in the heater 4, cold water supplied by the first feed pipe 16 is fed through the opened second valve 2 into the second feed pipe 17 for mixing with the heated water outgoing of the heater 4.

Directly downstream of the heater 4, a first temperature sensor 14 is arranged in the second feed pipe 16 for detecting the temperature of the outgoing water of the heater 4. A second temperature sensor 10 is arranged in the second feed pipe 16 directly upstream of the brewing chamber 1 for detecting the temperature of the water fed into the brewing chamber 1. The brewing chamber 1 is coupled with a portion sensor 9, which is determining the amount of coffee powder filled in the brewing chamber 1. A third temperature sensor 11 is arranged in the outlet pipe 21 for determining the temperature of the beverage.

A bypass pipe 22 is bypassing the brewing chamber 1 and is connecting the second feed pipe 17 with the outlet pipe 21. In the bypass pipe 22, a throttle valve 7 and a bypass valve 8 are arranged.

The beverage machine shown in FIG. 1 is electronically controlled by a control system, which is programmed to control the machine as follows:

The control system is driving the speed of the pump 5 in order to create an adjustable water pressure, which can be adjusted in combination of the water temperature. The diagram Temperature/Pressure is related to the desired flavour of the produced beverage. The pump 5 is transporting the cold water from the cold-water inlet 23 under the predefined pressure into the first feed pipe 16. Then the cold water goes into the heater 4. In the heater 4, the water will be heated to the programmed heating temperature (which preferably is between 85 and 110 ° C., corresponding to the standard needed for brewing a coffee beverage). The first temperature sensor 14 detects the heating temperature of the water and the control system is controlling the power of the heater 4 to hold the temperature of the water heated in the heater 4 to the predefined temperature value.

Downstream of the heater 4, the first valve 6, when opened, allows the heated water to flow into the brewing chamber 1 and going therein through the coffee powder and thus is brewing the coffee powder. The brewed coffee is flowing out of the brewing chamber 1 and into the outlet pipe 21 of the dispensing device 20. The dispensing device 20 is then discharging the brewed coffee beverage into a cup 12 standing underneath the outlet 24 of the dispensing device 20.

In this first mode of operation, the beverage machine is producing a hot coffee beverage. The second temperature sensor 10 here is detecting the water temperature streaming into the brewing chamber 1 and into the coffee powder and transfers this information to the control system, which monitors also the water temperature inside or directly downstream of the heater 4 using the first temperature sensor 14. The control system eventually will correct the reference heating temperature inside the heater 4, in order to maintain the programmed water temperature for brewing the coffee.

In a second mode of operation, the beverage machine is producing a cold coffee beverage. In this second mode of operation, the second valve 2 is opened and is directing the cold water supplied by the first feed pipe 16 and the pump 5 directly into the brewing chamber and through the coffee powder, without heating the water.

In a third mode of operation, the beverage machine is producing a warm coffee beverage. In this third mode of operation, the first valve 6 and the second valve 2 are sequentially opened and closed, in order to mix cold and hot water. Thereby, a predetermined water temperature being between the temperature of the cold water supplied by the pump 5 and the heated water supplied by the heater 4 can be achieved, depending on the on-/off-cycles of the first valve 6 and the second valve 2.

In each mode of operation, the brewed coffee is poured in the cup 12. Supplementary, by opening the bypass valve 8 hot, cold or warm clear water can be poured inside the cup 12, in order to modify the flavour profile of the produced beverage. The third temperature sensor 11 measures the temperature of the produced beverage poured in the cup 12. This temperature information of the third temperature sensor 11 is processed by the control system and depending on the flavour profile definition, the amount of water coming from the bypass 22 can be adjusted by the throttle valve 7. In every case, when the cup 12 is a PLA cup, the control system is stopping the discharge of beverage by the dispensing device 20, when the third temperature sensor 11 measures a temperature of the produced beverage of higher than 50° C.

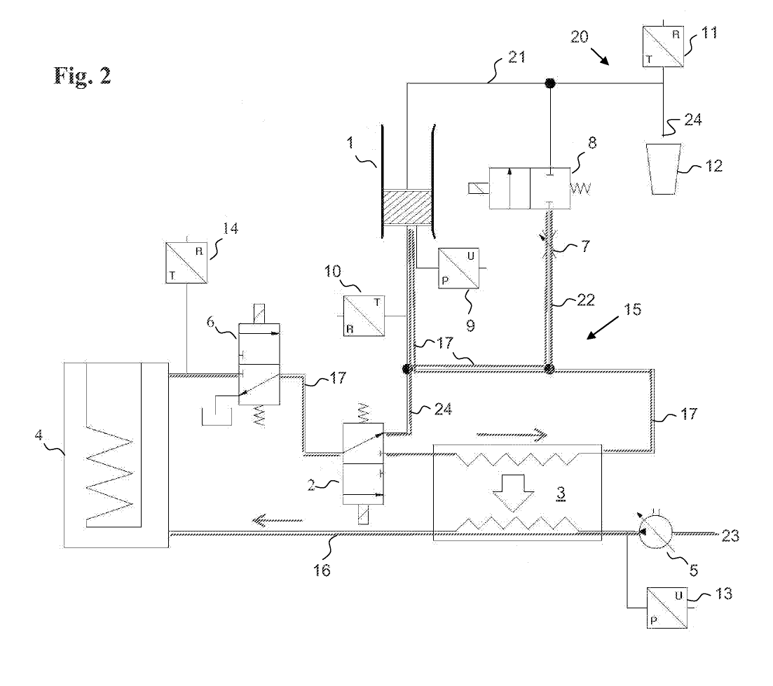

The second embodiment of a beverage machine according to the disclosure shown in FIG. 2 can be used with drinkable water or with water having no drinkable-water quality.

The hydraulic circuit of the second embodiment of a beverage machine shown in FIG. 2 also comprises a cold-water inlet 23 connected to a piping 15 with a first feed pipe 16, a second feed pipe 17, a pump 5 to supply pressurized water, a heater 4 for heating the water supplied by the pump 5, a brewing chamber 1 and a dispensing device 20 with an outlet pipe 21 having an outlet 24. As in the embodiment of FIG. 1, the piping 15 is fluidly connecting the pump 5, the heater 4 and the brewing chamber 1 for conducting pressurized water into the brewing chamber 1, with the second feed pipe 17 including a first valve 6, which is a 3-port/2-way directional control valve. The temperature sensors 10, 14 and 11, the pressure sensor 13 and the portion sensor 9 are the same as in the first embodiment of FIG. 1.

In the second embodiment according to FIG. 2, the cooler for cooling the water heated in the heater 4 is a heat exchanger 3, which is thermally coupling the first feed pipe 16 and the second feed pipe 17. Therefore, a primary side of the heat exchanger 3 is connected with the first feed pipe 16 and a secondary side of the heat exchanger 3 is connected with the second feed pipe 17. In the second feed pipe 17, upstream of the heat exchanger 3 and downstream of the first valve 6, a second valve 2 is arranged. The second valve 6 is a 3-port/2-way valve and can be a directional control valve or a proportional valve.

As in the embodiment of FIG. 1, a bypass pipe 22 including a throttle valve 7 and a bypass valve 8 is connecting the second feed pipe 17 and the outlet pipe 21 and is bypassing the brewing chamber 1.

A further bypass pipe 24 is arranged in the circuit of the second embodiment for connecting an outlet of the second valve 2 with the second feed pipe 17 under bypassing the heat exchanger 3. With this further bypass pipe 24, water outgoing of the heater 4 can be fed directly into the brewing chamber 1, without cooling the heated water, when the further bypass pipe 24 is opened by the second valve 2.

The beverage machine shown in FIG. 2 is electronically controlled by a control system, which is programmed to control the machine as follows:

The cold-water inlet 23 is providing cold water, which can be non-potable (impotable) water in this case. The control system is driving the speed of the pump 5 in order to create an adjustable water pressure. The diagram Temperature/Pressure is related to the desired flavour of the produced beverage. The pump 5 is supporting the cold water from the cold-water inlet 23 under the predefined pressure into the first feed pipe 16 and into the primary side of the heat exchanger 3. Downstream of the heat exchanger 3, the cold water goes inside the heater 4. In the heater 4, the water will be heated to the programmed heating temperature, which is at least 60° C. and preferably is between 85 and 110° C. (corresponding to the standard needed for brewing a coffee beverage). The first temperature sensor 14 detects the heating temperature of the water and the control system is controlling the power of the heater 4 to hold the temperature of the water heated in the heater 4 to the predefined temperature value. By heating the water in the heater to temperatures above 60° C., viruses and bacteria present in the (non-potable) water are killed. The heated and thus sterilized water then can be used for brewing beverages with hot, cold or warm water, depending of the customer's choice, as explained below.

Downstream of the heater 4, the first valve 6, when opened, and the second valve 2 allows the heated water to flow directly into the brewing chamber 1 and going through the coffee powder for brewing it. In a first mode of operation, a hot coffee beverage is produced, by directing the heated water outgoing from the heater 4 by the second valve 2 into the bypass pipe 24, which is bypassing the heat exchanger 3. From the bypass pipe 24, the hot water is flowing directly into the brewing chamber 1, without being cooled.

As in the first embodiment, the second temperature sensor 10 is detecting the water temperature coming inside the coffee powder and transfers this information to the control system, which monitors also the water temperature inside the heater 4 using the first temperature sensor 14. The control system is controlling the power of the heater 4, in order to maintain the programmed heating temperature.

In a second mode of operation, the second valve 2 directs the heated water coming from the heater 4 into the secondary side of the heat exchanger 3. In the heat exchanger 3, the heated water outgoing of the heater 4 is cooled by thermal transfer with the cold water supplied by the first feed pipe 16 and flowing through the primary side of the heat exchanger 3. The heated water is cooled in the heat exchanger 3 to temperatures in the range of 20° C. to 60° C., preferably below 50° C. Downstream of the heat exchanger 3, the cooled water is directed into the brewing chamber 1, to produce a cold coffee beverage, having a product temperature at the outlet 24, which in either case is below 50° C. The brewed beverage finally is poured into the cup 12, which then can be a PLA cup.

As in the first embodiment, supplementary hot or warm clear water can be poured through the bypass pipe 22 into the cup 12, when the bypass valve 8 is opened. The amount of the clear water poured into the cup 12 through the bypass pipe 22 can be selected by the throttle valve 7. When the second valve 2 is directing the hot water directly into the bypass pipe 24 and from there into the bypass pipe 22, the hot water is not cooled, since the heat exchanger 3 is bypassed. In this case, hot water is poured into the cup, in addition to the coffee flowing out of the brewing chamber 1 and the outlet pipe 21. When the second valve 2 is directing the hot water into the heat exchanger 3 and downstream of the heat exchanger 3 into the bypass pipe 22, the hot water is cooled in the heat exchanger 3 and is streaming as warm water into the cup 12. Also in this second mode of operation, the third temperature sensor 11 measures the temperature of the beverage poured in the cup 12, to ensure that a product temperature of 50° C. will not be exceeded.

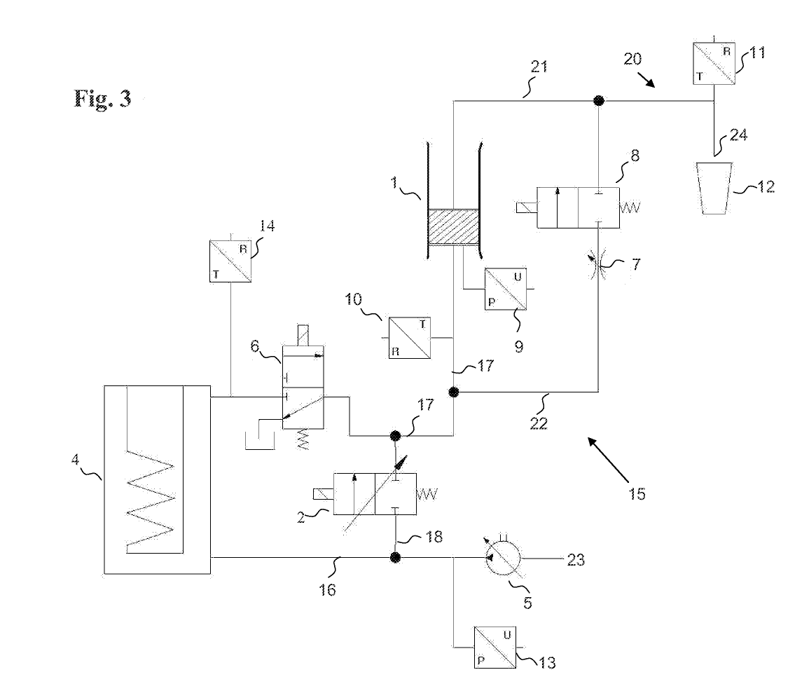

The third embodiment of a beverage machine according to the disclosure shown in FIG. 3 is equivalent to the first embodiment, except the second valve 2, which in the third embodiment is a variable-flow valve, in particular a proportional valve. The use of a variable-flow valve has the advantage, that a fine-adjustment of the mixing temperature of the mixed water can be made. The variable-flow valve 2 of the third embodiment enables to adjust the amount of cold water flowing from the first feed pipe 16 through the second valve 2 into the second feed pipe 17. Thereby, the mixing temperature of the mixed hot and cold water can be adjusted to a temperature value as needed.

What is claimed is:

1. A beverage machine for producing coffee-based beverages comprising
a pump to supply pressurized water,
a heater for heating the water supplied by the pump,
a brewing chamber, which is fillable with coffee powder,
a piping in fluid connection with the pump, the heater and the brewing chamber for conducting pressurized water into the brewing chamber, the piping comprising a first feed pipe between the pump and the heater and a second feed pipe between the heater and the brewing chamber, wherein the second feed pipe comprises a first valve,
a dispensing device for dispensing the coffee-based beverage produced in the brewing chamber by brewing the coffee powder with water supplied by the pump,
wherein a cooler is arranged in the second feed pipe downstream of the first valve for cooling the water heated by the heater.

2. The beverage machine according to claim 1, wherein the cooler is a mixer which mixes heated water outgoing of the heater with cold water supplied by the first feed pipe.

3. The beverage machine according to claim 1, wherein the cooler is a heat exchanger, which thermally couples the first feed pipe and the second feed pipe for cooling the heated water fed by the second feed pipe to the brewing chamber.

4. The beverage machine according to claim 3, wherein a bypass pipe bypasses the heat exchanger to feed heated water outgoing of the heater into the brewing chamber.

5. The beverage machine according to claim 2, wherein the piping comprises a connecting pipe connecting the first feed pipe and the second feed pipe and the mixer comprises a second valve arranged in the connecting pipe, whereby cold water supplied by the first feed pipe can be fed through the second valve into the second feed pipe for mixing with heated water outgoing of the heater.

6. The beverage machine according to claim 3, wherein a second valve is arranged in the second feed pipe downstream of the first valve.

7. The beverage machine according to claim 6, wherein at least one of the first valve and the second valve is a switching valve.

8. The beverage machine according to claim 1, wherein a pressure sensor is arranged in the first feed pipe.

9. The beverage machine according to claim 1, wherein at least one of a first temperature sensor is arranged in the second feed pipe directly downstream of the heater for detecting the temperature of the outgoing water of the heater and a second temperature sensor is arranged in the second feed pipe directly upstream of the brewing chamber for detecting the temperature of the water fed into the brewing chamber.

10. The beverage machine according to claim 1, wherein the brewing chamber is coupled with a portion sensor which determines the amount of coffee powder filled in the brewing chamber.

11. The beverage machine according to claim 1, wherein the dispensing device comprises an outlet pipe for discharging the beverage into a container.

12. The beverage machine according to claim 11, wherein a third temperature sensor is arranged in the outlet pipe for determining the beverage temperature.

13. The beverage machine according to claim 11, wherein a bypass pipe bypasses the brewing chamber and connects the second feed pipe with the outlet pipe.

14. The beverage machine according to claim 13, wherein at least one of a throttle valve and a bypass valve is arranged in the bypass pipe.

15. A method for producing coffee-based beverages in a beverage machine, comprising the following steps:
supplying pressurized water to a heater,
heating the supplied water in the heater to temperatures of at least 60° C., preferably to more than 80° C.,
filling a brewing chamber with coffee powder,
conducting the water heated in the heater into the brewing chamber filled with coffee powder for brewing the coffee powder, thereby producing the coffee-based beverage,
dispensing the coffee-based beverage produced in the brewing chamber by a dispensing device,
wherein the water heated by the heater is cooled in a cooler before the water is conducted into the brewing chamber.

16. The beverage machine according to claim 7, wherein the first valve is a solenoid valve.

17. The beverage machine according to claim 7, wherein the second valve is a solenoid valve, or a variable-flow valve.

18. The beverage machine according to claim 17, wherein the second valve is a proportional valve.
